(19) United States
(12) Patent Application Publication
(10) Pub. No.: US 2017/0024829 A1
(43) Pub. Date: Jan. 26, 2017

(54) METHOD AND SYSTEM FOR COLLECTING INDIRECT TAX

(71) Applicant: MasterCard International Incorporated, Purchase, NY (US)

(72) Inventors: Sumit Mittal, New Delhi (IN); Pradeep Shekhawat, Gurgaon Haryana (IN); Ravi Ayyalasomayajula, Gurgaon Haryana (IN); Aditya Agarwal, Gurgaon (IN)

(21) Appl. No.: 15/211,324

(22) Filed: Jul. 15, 2016

(30) Foreign Application Priority Data
Jul. 22, 2015 (SG) 10201505709V

(51) Int. Cl. G06Q 40/00

(52) U.S. Cl. CPC G06Q 40/123

(57) ABSTRACT

A method for collecting indirect tax associated with a transaction, the method being performed using a tax collection module, and comprising the steps of: determining that an indirect tax is due on the transaction having a transaction value; calculating the amount of indirect tax due on the transaction; deducting the calculated amount of indirect tax due on the transaction from the transaction value at a time associated with settlement of the transaction; and forwarding the deducted amount to a tax collecting entity at the time associated with settlement of the transaction.

### CROSS-REFERENCE TO RELATED APPLICATION

This application is a U.S. National Stage filing under 35 U.S.C. §119, based on and claiming benefit of and priority to SG Patent Application No. 10201505709V filed Jul. 22, 2015.

### TECHNICAL FIELD OF INVENTION

The following discloses a method and system for collecting indirect tax.

### BACKGROUND

Governments usually levy various indirect taxes on goods or services. Such indirect taxes (e.g. sales tax, airport passenger tax, value added tax (VAT), goods and services tax (GST), etc.) are typically collected by an intermediary (e.g. a merchant/retail store) from the person who bears the economic burden of the tax (e.g. the consumer). The intermediary subsequently files a tax return and forwards the tax proceeds to the government with the return. In contrast with indirect taxes, direct taxes (e.g. income tax) are paid directly to the government by the person on whom it is imposed.

This current indirect tax collection mechanism presents a number of challenges for the government. For example, the indirect taxes are only received from the intermediary after a period of time. That is, instead of tax collection during the purchase of goods or services, there is a delay in tax collection. Furthermore, it may be difficult to ensure that the tax payable for each and every transaction is collected. This may be more significant in developing countries/markets, where there may be a systematic “leakage” when transactions occur (and taxes are due) but the taxes are not paid by the intermediary and/or consumer.

Governments need to spend additional resources to reduce the leakage, such as engaging tax inspectors to check that intermediaries are forwarding all the payable tax proceeds to the government.

In summary, the current indirect tax collection mechanism results in delays and/or reduction in tax revenue.

A need therefore exists to provide method(s) and system(s) for collecting indirect tax that seek to address at least the above-mentioned problems.

### SUMMARY

According to a first aspect of the invention, there is provided a method for collecting indirect tax associated with a transaction, the method being performed using a tax collection module, and comprising: determining that an indirect tax is due on the transaction having a transaction value; calculating the amount of indirect tax due on the transaction; deducting the calculated amount of indirect tax due on the transaction from the transaction value at a time associated with settlement of the transaction; and forwarding the deducted amount to a tax collecting entity at the time associated with settlement of the transaction.

In an embodiment, determining that an indirect tax is due on the transaction may comprise checking transaction data associated with the transaction, the transaction data comprising an identifier indicating that an indirect tax is due on the transaction.

In an embodiment, calculating the amount of indirect tax due on the transaction may comprise checking transaction data associated with the transaction, the transaction data comprising an identifier indicating the rate or amount of indirect tax due on the transaction.

In an embodiment, the identifier indicating that an indirect tax is due on the transaction and the identifier indicating the rate or amount of indirect tax due on the transaction may be the same.

In an embodiment, the identifier indicating that an indirect tax is due on the transaction or the identifier indicating the rate or amount of indirect tax due on the transaction may comprise one or more of: product category, merchant category or tax information.

In an embodiment, the transaction may be an electronic payment transaction and the transaction may be settled between an issuing entity and an acquiring entity, through a payment facilitator.

In an embodiment, a time associated with settlement of the transaction may start when the transaction is first settled between the issuing entity and the payment facilitator, and may end when the transaction is finally settled between the acquiring entity and the payment facilitator.

According to a second aspect of the invention, there is provided a tax collection module comprising: at least one processor; and at least one memory including computer program code; the at least one memory and the computer program code configured to, with at least one processor, cause the tax collection module at least to: determine that an indirect tax is due on a transaction having a transaction value; calculate the amount of indirect tax due on the transaction; deduct the calculated amount of indirect tax due on the transaction from the transaction value at a time associated with settlement of the transaction; and forward the deducted amount to a tax receipt module at the time associated with settlement of the transaction.

In an embodiment, the tax collection module may be further caused to check transaction data associated with the transaction to determine that an indirect tax is due on the transaction, the transaction data comprising an identifier indicating that an indirect tax is due on the transaction.

In an embodiment, the tax collection module may be further caused to check transaction data associated with the transaction to calculate the amount of indirect tax due on the transaction, the transaction data comprising an identifier indicating the rate or amount of indirect tax due on the transaction.

In an embodiment, the identifier indicating that an indirect tax is due on the transaction and the identifier indicating the rate or amount of indirect tax due on the transaction may be the same.

In an embodiment, the identifier indicating that an indirect tax is due on the transaction or the identifier indicating the rate or amount of indirect tax due on the transaction may comprise one or more of: product category, merchant category or tax information.

In an embodiment, the transaction may be an electronic payment transaction and the transaction may be settled between an issuing entity and an acquiring entity, through a payment facilitator.

In an embodiment, a time associated with settlement of the transaction may start when the transaction is first settled between the issuing entity and the payment facilitator, and may end when the transaction is finally settled between the acquiring entity and the payment facilitator.

### BRIEF DESCRIPTION OF THE DRAWINGS

Embodiments of the invention will be better understood and readily apparent to one of ordinary skill in the art from the following written description, by way of example only, and in conjunction with the drawings, in which:

FIG. 1 is a schematic of a system in which indirect tax collection may be performed;

FIG. 2 shows an exemplary computing device to realize a server for the acquirer server, payment network server, issuer server, tax collection module and/or tax receipt module shown in FIG. 1;

FIG. 3 shows a flowchart depicting steps of a method for collecting indirect tax; and

FIG. 4 shows a schematic of a server to implement a tax collection module.

### DETAILED DESCRIPTION

Embodiments will be described, by way of example only, with reference to the drawings. Like reference numerals and characters in the drawings refer to like elements or equivalents.

Embodiments of the invention relate to method(s) and system(s) for collecting indirect taxes that seek to reduce delays in receipt of tax revenue and also to minimize “leakage” (i.e. transactions occur and taxes are due but the taxes are not paid by intermediaries and/or consumers).

In the following description, indirect taxes refer to taxes that are collected by an intermediary from the person who bears the economic burden of the tax (e.g. the consumer). Examples of indirect taxes include sales tax, airport passenger tax, value added tax (VAT), goods and services tax (GST), etc. The intermediary subsequently forwards the tax to the government.

Various goods or services may be subject to different indirect taxes. For example, there may be a higher indirect tax for alcohol or tobacco compared to groceries. Some indirect taxes may be a percentage of the price of the good or service (e.g. a VAT of 10% on all products) or a fixed amount (e.g. fixed airport passenger tax regardless of whether the passenger is flying on business or economy class).

In contrast with indirect taxes, direct taxes are paid directly to the government by the person on whom it is imposed.

In an exemplary implementation, the indirect taxes are captured at a time associated with settlement of the transaction. In other words, the indirect taxes are forwarded to the government as part of the transaction, more or less in “real-time”, i.e. at or around the same time the transaction is completed, as opposed to consolidating transactions that occur over a period of time and then forwarding the taxes due on them to the relevant government agency. In this manner, embodiments of the invention advantageously provide greater transparency in reducing indirect tax collection costs.

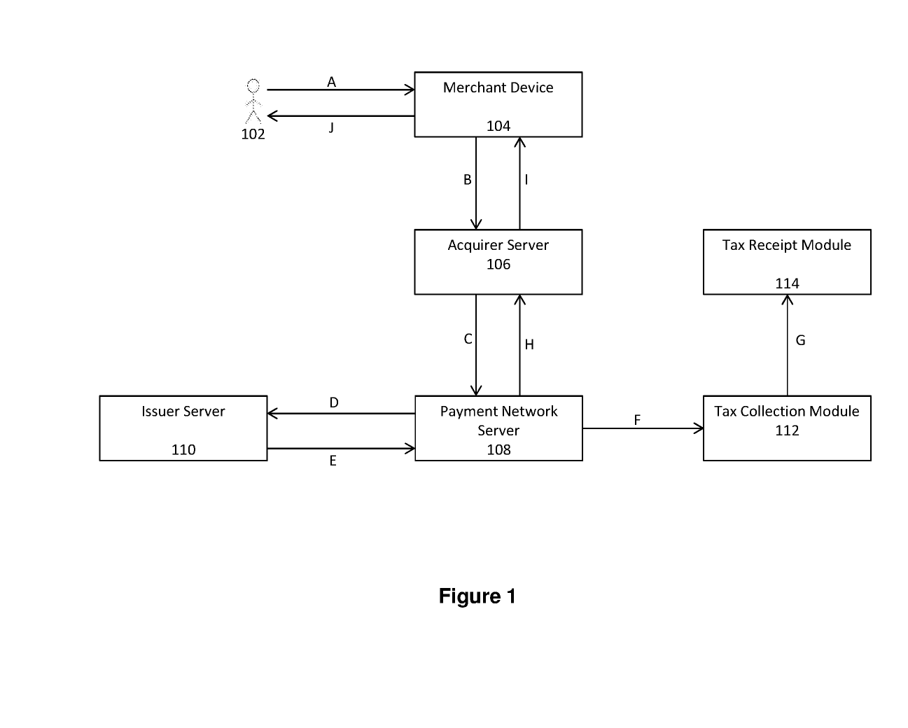

FIG. 1 is a diagram illustrating a system 100 in which indirect tax collection may be performed. The system 100 comprises a merchant device 104, an acquirer server 106, a payment network server 108, an issuer server 110, a tax collection module 112 and a tax receipt module 114.

The merchant device 104 is in communication with the acquirer server 106. The acquirer server 106 is in communication with the payment network server 108. The payment network server 108 is in communication with the issuer server 110. The tax collection module 112 may be integrated with the payment network server 108 or configured as a stand-alone module. In the stand-alone configuration as shown in FIG. 1, the payment network server 108 is in communication with the tax collection module 112. In both the integrated and stand-alone configurations, the tax collection module 112 is in communication with the tax receipt module 114.

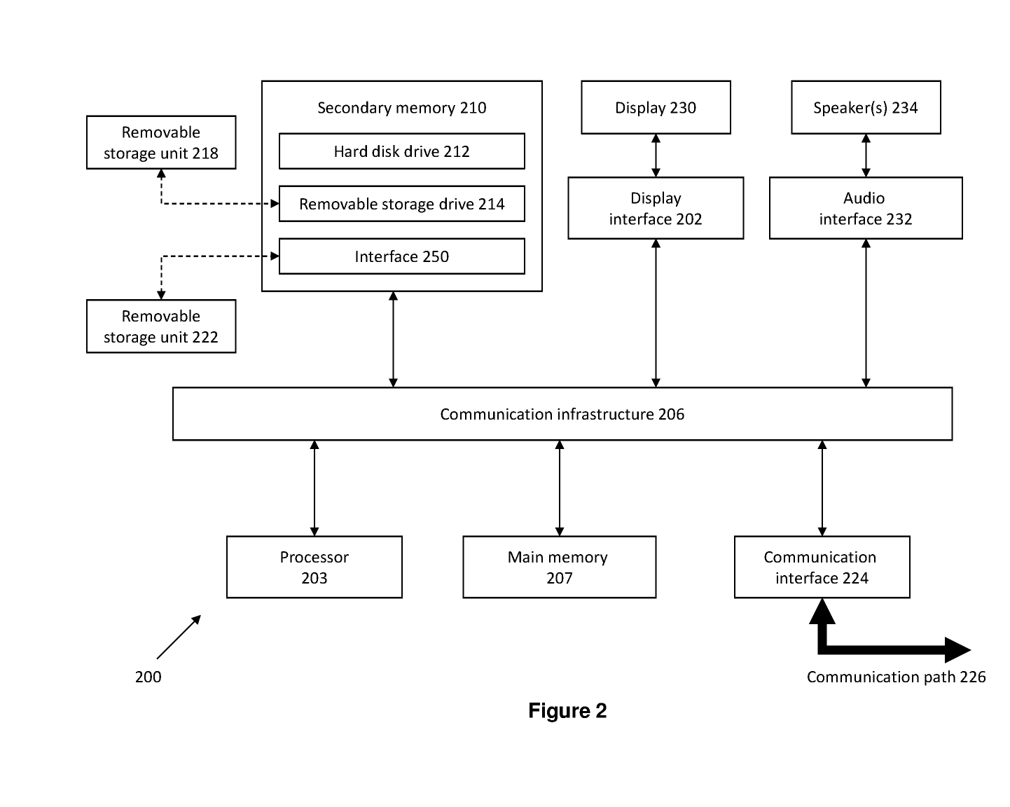

Use of the term ‘server’ herein may be understood to mean a single computing device or a plurality of interconnected computing devices which operate together to perform a particular function. That is, the server may be contained within a single hardware unit or be distributed among several or many different hardware units. An exemplary computing device which may be operated as a server is described below with reference to FIG. 2.

Turning back to FIG. 1, a consumer 102 (e.g. a customer who wishes to purchase a good or service) is a party to a transaction. Here, the transaction refers to an electronic payment transaction involving one or more of a consumer, a merchant, an issuing entity, an acquiring entity and a payment facilitator.

The merchant device 104 is associated with the merchant who is also a party to the transaction. The merchant device 104 may be a point-of-sale (POS) terminal, a personal computer, a computer server (hosting a website, for example), a land-line telephone, or any type of mobile device such as a mobile phone, a laptop computer, a tablet computer and the like.

The acquirer server 106 is associated with the acquiring entity who may be an entity (e.g. a company or organization) which issues (e.g. establishes, manages, administers) an account (e.g. a financial bank account) of the merchant. Examples of the acquiring entity include a bank and/or other financial institution. The acquirer server 106 may include one or more computing devices that are used to establish communication with another server by exchanging messages with and/or passing information to the other server.

The payment network server 108 is associated with the payment facilitator. The payment facilitator may be an entity (e.g. a company or organization) that facilitates the processing of transactions, such as clearing and settling funds for payments between two or more entities (e.g. two banks). The payment network server 108 may include one or more computing devices that are used for processing transactions.

The issuer server 110 is associated with the issuing entity and may include one or more computing devices that are used to perform a payment transaction. The issuing entity may be an entity (e.g. a company or organization) which issues (e.g. establishes, manages, administers) an account (e.g. a financial bank account) of the consumer 102. The tax collection module 112 may be administered by the payment facilitator and may include one or more computing devices that are configured to: (i) determine that an indirect tax is due on a transaction; (ii) calculate the amount of indirect tax due on the transaction; (iii) deduct the calculated amount of tax due on the transaction; and/or forward the deducted amount to a tax collecting entity (e.g. a government agency) at a time associated with settlement of the transaction.

The tax receipt module 114 may be administered by a tax collecting entity (e.g. a government agency) and may include one or more computing devices that are configured to receive indirect taxes forwarded from the tax collection module 112.

With reference to FIG. 1, the consumer 102 wishes to purchase a good or service that is offered for sale by a merchant. If an indirect tax is due on the good or service, this is factored into the cost of the good or service. At step A, the consumer 102 pays for the good or service with a credit/debit card that is issued to him by the issuing entity (i.e. the consumer's bank). The issuing entity provides payment instruments, such as a credit or a debit card, for holders (i.e. the customer 102) of such instruments to make purchases from the merchant. The issuing entity typically provides the owner of such payment instruments a credit line (especially in the case of the credit card) against which is checked whether there are sufficient funds to pay for a transaction initiated by the holder of a payment instrument.

In this example, the cost of the purchased good or service is $100. The merchant uses the merchant device 104 (e.g. a point-of-sale (POS) terminal) to facilitate the transaction.

At step B, the merchant device 104 sends transaction data (e.g. a transaction request message) to the acquirer server 106. At step C, the acquirer server 106 in turn sends the transaction data to the payment network server 108. At step D, the payment network server 108 then directs the transaction data to the issuer server 110. The issuer server 110 is configured to perform several checks, such as the credit available to the consumer. For example, in the case of a credit card, the issuer server 110 checks whether the consumer's credit limit is exceeded if the good or service is purchased. If there is still credit available to the consumer, the transaction is approved.

Upon approval, at step E, the transaction data (which may now include a transaction approval message) is sent from the issuer server 110 to the payment network server 108. Besides the transaction request message and transaction approval message, the transaction data may comprise one or more identifiers. Also, at step E, the issuing entity settles the transaction with the payment facilitator. The issuing entity collects an interchange amount and pays the remainder to the payment facilitator. For example, if the cost of the purchased good or service is $100 and the interchange rate is 2%, the issuing entity collects $2 and pays the payment facilitator $98.

In the stand-alone configuration as shown in FIG. 1, the payment network server 108 is physically separate from the tax collection module 112. At step F, the payment network server 108 sends the transaction data (comprising one or more identifiers) to the tax collection module 112. The tax collection module 112 is configured to process/analyze the transaction data, and based on the processing/analysis, is configured, at least, to: (i) determine that an indirect tax is due on the transaction; (ii) calculate the amount of indirect tax due on the transaction; (iii) deduct the calculated amount of tax due on the transaction; and/or forward the deducted amount to the tax receipt module 114 (see step G).

In the integrated configuration, the tax collection module 112 is integrated with the payment network server 108. For example, a single server may be configured to realize both the tax collection module 112 and payment network server 108. In this case, the single server is configured to process/analyze the transaction data (received from the issuer server 110), and based on the processing/analysis, is configured, at least, to: (i) determine that an indirect tax is due on the transaction; (ii) calculate the amount of indirect tax due on the transaction; (iii) deduct the calculated amount of tax due on the transaction; and/or forward the deducted amount to the tax receipt module 114 (see step G).

In any case, the tax collection module 112 recognizes that the transaction is one which indirect tax is payable to the tax collecting entity and proceeds to forward the indirect tax to the tax collecting entity. For example, if the cost of the purchased good or service is $100 and a 10% VAT is payable, the tax collection module 112 deducts $10 from the $98 (from step E), and forwards the deducted $10 to the tax receipt module 114 (at step G). Having the indirect tax immediately automatically collected after each transaction requires less policing from the tax collecting entity. For the merchant, it would also reduce the number of transactions that need to be monitored to ensure that tax has been paid on them.

At step H, the payment network server 108 sends the transaction data (which may include a transaction approval message) to the acquirer server 106. The payment facilitator settles the remaining amount (less the interchange and indirect tax) with the acquiring entity. Continuing from the earlier example, where (i) a 10% VAT is due on the $100 good or service and (ii) the interchange rate is 2%, the remaining amount is $88 ($100−$10 indirect tax−$2interchange=$88). In this example, it is assumed that the payment facilitator does not charge any processing fee.

At step I, the acquiring entity in turn sends the transaction data to the merchant device 104. For example, the POS terminal may receive a message that the transaction has been authorized. The acquiring entity settles the transaction with the merchant. For example, assuming that the acquiring entity does not charge any processing fee, the acquiring entity forwards $88 to the merchant.

At step J, upon receipt of transaction approval, the merchant delivers the good or service to the consumer.

In FIG. 1, steps B, C and D constitute an authorization phase of the transaction. Steps E, H and I constitute settlement of the transaction. Steps F and G constitute a tax collection phase of the transaction. The tax collection phase occurs at a time associated with settlement of the transaction. That is, steps F and G are initiated after step E; and are completed before steps H and I are completed.

FIG. 2 shows an exemplary computing device to realize a server for the acquirer server, payment network server, issuer server, tax collection module and/or tax receipt module shown in FIG. 1. The following description of the computing device 200 is provided by way of example only and is not intended to be limiting. Therefore, one or more elements/components of the computing device 200 may be omitted. Also, one or more elements/components of the computing device 200 may be combined together. Additionally, one or more elements/components of the computing device 200 may be split into one or more component parts.

With reference to FIG. 2, the exemplary computing device 200 includes a processor 203 for executing software routines. Although a single processor is shown for the sake of clarity, the computing device 200 may also include a multi-processor system. The processor 203 is connected to a communication infrastructure 206 for communication with other components of the computing device 200. The communication infrastructure 206 may include, for example, a communications bus, cross-bar, or network.

The computing device 200 further includes a main memory 207, such as a random access memory (RAM), and a secondary memory 210. The secondary memory 210 may include, for example, a hard disk drive 212 and/or a removable storage drive 214, which may include a magnetic tape drive, an optical disk drive, or the like. The removable storage drive 214 reads from and/or writes to a removable storage unit 218 in a well-known manner. The removable storage unit 218 may include a magnetic disk, optical disk, or the like, which is read by and written to by removable storage drive 214. As will be appreciated by persons skilled in the relevant art(s), the removable storage unit 218 includes a computer readable storage medium having stored therein computer executable program code instructions and/or data.

In an alternative implementation, the secondary memory 210 may additionally or alternatively include other similar means for allowing computer programs or other instructions to be loaded into the computing device 200. Such means can include, for example, a removable storage unit 222 and an interface 250. Examples of a removable storage unit 222 and interface 250 include a program cartridge and cartridge interface, a removable memory chip (such as an EPROM or PROM) and associated socket, and other removable storage units 222 and interfaces 250 which allow software and data to be transferred from the removable storage unit 222 to the computing device 200.

The computing device 200 also includes at least one communication interface 224. The communication interface 224 allows software and data to be transferred between computing device 200 and external devices via a communication path 226. In various implementations, the communication interface 224 permits data to be transferred between the computing device 200 and a data communication network, such as a public data or private data communication network. The communication interface 224 may be used to exchange data between different computing devices 200 which such computing devices 200 form part an interconnected computer network. Examples of a communication interface 224 can include a modem, a network interface (such as an Ethernet card), a communication port, an antenna with associated circuitry and the like. The communication interface 224 may be wired or may be wireless. Software and data transferred via the communication interface 224 are in the form of signals which can be electronic, electromagnetic, optical or other signals capable of being received by communication interface 224. These signals are provided to the communication interface via the communication path 226.

As shown in FIG. 2, the computing device 200 further includes a display interface 202 which performs operations for rendering images to an associated display 230 and an audio interface 232 for performing operations for playing audio content via associated speaker(s) 234.

As used herein, the term “computer program product” may refer, in part, to removable storage unit 218, removable storage unit 222, a hard disk installed in hard disk drive 212, or a carrier wave carrying software over communication path 226 (wireless link or cable) to communication interface 224. A computer readable medium can include magnetic media, optical media, or other recordable media, or media that transmits a carrier wave or other signal. These computer program products are devices for providing software to the computing device 200. Computer readable storage medium refers to any non-transitory tangible storage medium that provides recorded instructions and/or data to the computing device 200 for execution and/or processing. Examples of such storage media include floppy disks, magnetic tape, CD-ROM, DVD, Blu-ray Disc™, a hard disk drive, a ROM or integrated circuit, USB memory, a magneto-optical disk, or a computer readable card such as a PCMCIA card and the like, whether or not such devices are internal or external of the computing device 200. Examples of transitory or non-tangible computer readable transmission media that may also participate in the provision of software, application programs, instructions and/or data to the computing device 200 include radio or infra-red transmission channels as well as a network connection to another computer or networked device, and the Internet or Intranets including e-mail transmissions and information recorded on Websites and the like.

The computer programs (also called computer program code) are stored in main memory 207 and/or secondary memory 210. Computer programs can also be received via the communication interface 224. Such computer programs, when executed, enable the computing device 200 to perform one or more steps that facilitate the collection of indirect taxes. The computer programs, when executed, enable the processor 203 to facilitate the collection of indirect taxes. Accordingly, such computer programs may represent controllers of the computing device 200.

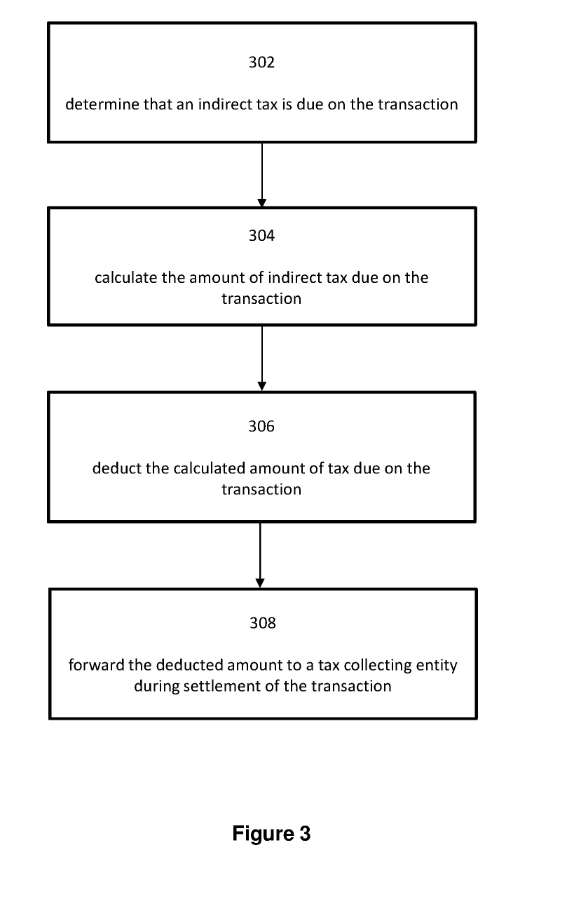

Software may be stored in a computer program product and loaded into the computing device 200 using the removable storage drive 214, the hard disk drive 212, or the interface 250. Alternatively, the computer program product may be downloaded to the computing device 200 over the communications path 226. The software, when executed by the processor 203, causes the computing device 200 to perform the necessary operations to execute one or more steps that facilitate the collection of indirect taxes, such as those shown and described below with respect to FIG. 3.

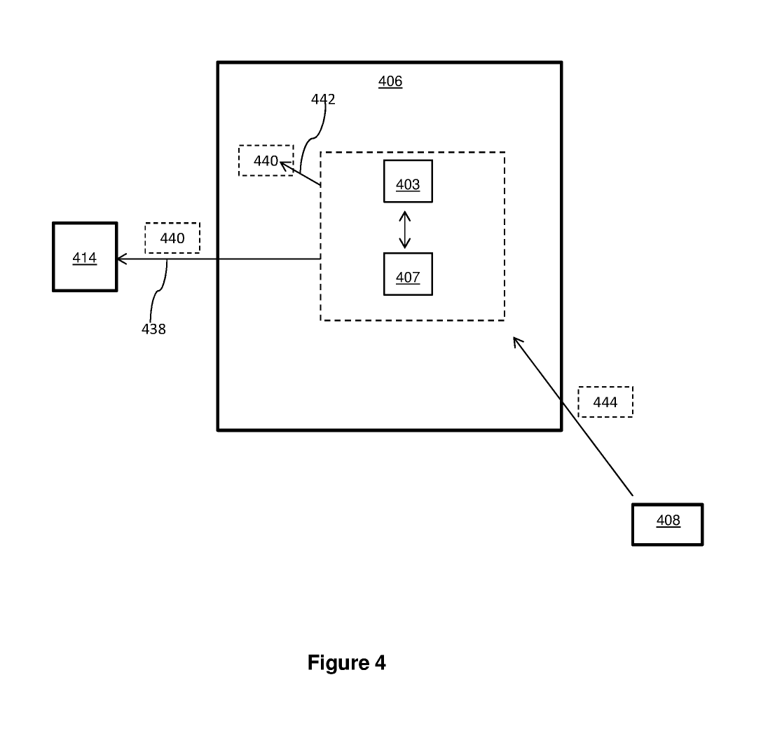

FIG. 3 shows a flowchart depicting steps of a method for collecting indirect tax associated with a transaction. The method may be implemented using a tax collection module, which will be described in more detail below with reference to FIG. 4. The method includes the following steps as detailed below and described with reference to FIG. 1. The transaction may be an electronic payment transaction and the transaction is settled between an issuing entity (such as via the issuer server 110 shown in FIG. 1) and an acquiring entity (such as via the acquirer server 106 shown in FIG. 1) through a payment facilitator (such as via the payment network server 108 shown in FIG. 1).

Step 302 involves determining whether or not an indirect tax is due on the transaction having a transaction value. In an exemplary implementation, determining whether or not an indirect tax is due on the transaction comprises checking/analyzing transaction data associated with the transaction. The transaction data may include one or more identifiers such as product category, merchant category, and tax information.

For example, the identifier “tax information” may contain data indicating whether or not indirect tax is due on the transaction. The tax information can be checked and if indirect tax is due on the transaction, the transaction can be further processed for appropriate tax collection. Otherwise, no further processing of the transaction is performed in relation to indirect tax collection. The identifier “tax information” may be additional data appended to existing transaction data associated with electronic payment transactions. In its simplest form, the “tax information” may be a data bit (e.g. “1” representing indirect tax is due, and “0” representing indirect tax not due). Systems for processing electronic payment transactions (such as system 100) may need to be re-configured to process the additional data that is appended to the existing transaction data.

In another example, the identifier “product category” may be used to indicate whether or not indirect tax is due on the transaction. If “product category” already exists in transaction data associated with electronic payment transactions, systems for processing electronic payment transactions (such as system 100) may not need to be configured to process the identifier. In an example, the “product category” is Alcohol and a consumer 102 purchases a bottle of beer. Assume that in a particular market, all alcohol purchases are subject to additional indirect taxes. Since the “product category” is Alcohol, it may mean that the transaction is subject to the additional indirect tax and the transaction can be further processed for appropriate tax collection. If the “product category” is a non-taxable category (e.g. donations to a charitable organization), no further processing of the transaction is performed in relation to indirect tax collection.

In another implementation, the identifier “merchant category” may be used to indicate whether or not indirect tax is due on the transaction. If “merchant category” already exists in transaction data associated with electronic payment transactions, systems for processing electronic payment transactions (such as system 100) may not need to be configured to process the identifier. The “merchant category” identifier may be a merchant category code (MCC) that is used to identify the type of business conducted by the merchant. The MCC may be a numeric code. In an example, the “merchant category” is Restaurant and a consumer 102 purchases some food and beverage. Assume that in a particular market, all food and beverage purchases at restaurants are subject to indirect tax. Since the “merchant category” is Restaurant, it may mean that the transaction is subject to the indirect tax and the transaction can be further processed for appropriate tax collection. If the “merchant category” is a non-taxable category (e.g. Hospital), no further processing of the transaction is performed in relation to indirect tax collection.

In a further implementation, two or more identifiers may be used for determining whether or not indirect tax is due on the transaction. For example, both the identifiers “merchant information” and “product category” can be used. Continuing from the examples above, assume that in a particular market, all food and non-alcoholic beverage purchases at restaurants are subject to a basic indirect tax, and all alcoholic purchases attract an additional indirect tax. During processing, it can be detected that the “merchant category” is Restaurant, thus the transaction is subject to the basic indirect tax. If some wine was purchased during the meal at the restaurant, it can be detected that the “product category” of the wine is Alcohol, and the wine is subject to the additional indirect tax.

The identifiers may be in any suitable form, such as a data bit or a code comprising a string of alphabets, numerals and/or special characters. The identifiers can be used to indicate whether or not indirect tax is due on the transaction.

If, at step 302, it is determined that an indirect tax is due on the transaction, step 304 may be initiated. Step 304 involves calculating the amount of indirect tax due on the transaction. In an exemplary implementation, calculating the amount of indirect tax due on the transaction comprises checking/analysing transaction data associated with the transaction. Similar to step 302, the transaction data may include one or more identifiers such as product category, merchant category, and tax information.

Continuing from the example above, the identifier “tax information” may contain data indicating the amount of indirect tax due on the transaction. The tax information can be analysed to extract the amount of indirect tax due on the transaction. For example, the identifier “tax information” may contain the tax rate (e.g. 10%) due on the good or service purchased. Based on the extracted information, the amount of indirect tax due on the transaction can be calculated. The identifier “tax information” may be additional data appended to existing transaction data associated with electronic payment transactions. Systems for processing electronic payment transactions (such as system 100) may need to be re-configured to process the additional data that is appended to the existing transaction data.

Continuing from the other example above, the identifier “product category” may be used to indicate the amount of indirect tax due on the transaction or provide information regarding the amount of indirect tax due on the transaction. If “product category” already exists in transaction data associated with electronic payment transactions, systems for processing electronic payment transactions (such as system 100) may not need to be configured to process the identifier. Assume that in a particular market, all alcohol purchases are subject to indirect taxes of 5%. Since the “product category” is alcohol, it may mean that the transaction is subject to a 5% indirect tax and the amount of indirect tax can be calculated. A database may store a list of product categories and the corresponding tax rate. The database may be accessed and using e.g. a look-up procedure, the applicable tax rate for a certain product category can be retrieved.

For further illustration, assume that in a particular market, all flights departing from the airport are subject to a fixed airport passenger tax (regardless of whether the passenger is flying on business or economy class). Accordingly, if the “product category” is airport tax, it may mean that the transaction is subject to the fixed airport passenger tax.

In another example, the identifier “merchant category” may be used to provide information regarding the rate or amount of indirect tax due on the transaction. Assume that in a particular market, all purchases at a restaurant are subject to indirect taxes of 5%. If the “merchant category” is Restaurant, the transaction is subject to the 5% indirect tax and the amount of indirect tax can be calculated. A database may store a list of merchant categories and the corresponding tax rate. The database may be accessed and using e.g. a look-up procedure, the applicable tax rate for a certain merchant category can be retrieved.

In the examples above, the identifiers can be used to (i) provide information regarding the rate or amount of indirect tax due on the transaction and/or (ii) indicate the rate or amount of indirect tax due on the transaction. Based on the rate of indirect tax due on the transaction, the amount of indirect tax due on the transaction can be calculated.

The identifier used in step 302 (a first identifier) and step 304 (a second identifier) can be the same for both steps (e.g. the identifier “product category” is used to determine whether an indirect tax is due and calculate the amount of indirect tax due on a transaction) or may be different for both steps (e.g. the identifier “product category” is used to determine whether an indirect tax is due and the identifier “tax information” is used to calculate the amount of indirect tax due on a transaction). That is, the first and second identifier may be the same or may be different.

After the amount of indirect tax due on the transaction is calculated at step 304, step 306 may be initiated. Step 306 involves deducting the calculated amount of indirect tax due on the transaction from the transaction value at a time associated with settlement of the transaction.

Continuing from the example above where the identifier “product category” is used and all alcohol purchases are subject to indirect taxes of 5% of the price of the good or service, assume that the bottle of beer purchased by the consumer 102 costs $10. The amount of indirect tax calculated in step 304 above is 50 cents (5% of $10).

Accordingly, 50 cents is deducted from the transaction amount.

After the calculated amount of tax due on the transaction rate is deducted at step 306, step 308 may be initiated. Step 308 involves forwarding the deducted amount to a tax collecting entity (e.g. government agency, airport authority) at the time associated with settlement of the transaction.

The transaction comprises three phases: authorization, settlement and tax collection. The tax collection phase involves steps 302, 304, 306 and 308; and occurs at a time associated with settlement of the transaction.

In an implementation, steps 302, 304, 306 and 308 are initiated after step E (see FIG. 1); and are completed before step I (also see FIG. 1) is completed. In other words, the step of deducting the calculated amount of tax due on the transaction (i.e. step 306) may be performed after the settlement with the issuing entity (step E). Further, the step of forwarding the deducted amount to the tax collecting entity (i.e. step 308) may be performed before the settlement with the acquiring entity (step H) and merchant (step I).

In the prior art, indirect taxes are typically collected by an intermediary (e.g. a merchant/retail store) from the person who bears the economic burden of the tax (e.g. the consumer). The intermediary subsequently files a tax return (after settlement of the transaction with the issuing entity, acquiring entity and consumer) and forwards the tax proceeds to the government with the return.

In stark contrast to the prior art, in embodiments of the invention, the forwarding is performed at a time associated with settlement of the transaction. In this manner, the government agency receives the indirect tax without much delay, and there is a reduction in leakage as all taxable transactions are recognized and the correct amount is tax is deducted through the payment facilitator and forwarded to the government agency at the point of settlement. As merchants are excluded from the tax forwarding process, government agencies do not need to check that each and every merchant that collects tax from consumers eventually pays the government agency the correct amount. As a result, less auditing is required and merchants need not spend additional resources to file tax returns and forward the tax proceeds to the government.

FIG. 4 shows a schematic of a server 406 to realize/implement the tax collection module 112 shown in FIG. 1. The server 406 includes at least one processor 403 and at least one memory 407. Other components of the server 406 have been omitted for the purposes of simplicity. In this instance, the tax collection module 112 is configured as a stand-alone server module. That is, the tax collection module 112 (server 406) is physically separate from the payment network server 108. The server 406 is in communication with the payment network server 408 and a tax receipt module 414.

Computer program code within the at least one memory 407 is configured to have the at least one memory 407, with the at least one processor 403, cause the server 406 to: (i) determine that an indirect tax is due on a transaction having a transaction value; (ii) calculate 442 the amount of indirect tax 440 due on the transaction; (iii) deduct the calculated amount of indirect tax due on the transaction from the transaction value at a time associated with settlement of the transaction; and (iv) forward 438 the deducted amount 440 to a tax receipt module 414 (administered by a tax collecting entity) at the time associated with settlement of the transaction. The transaction may be an electronic payment transaction and the transaction is settled between an issuing entity and an acquiring entity through a payment facilitator.

The payment facilitator may administer the payment network server 408.

In an implementation, the tax collection module can be further caused to check transaction data associated with the transaction to determine that an indirect tax is due on the transaction. The transaction data 444 may be received from the payment network server 408 and may comprise a first identifier indicating that an indirect tax is due on the transaction.

The tax collection module can also be further caused to check transaction data associated with the transaction to calculate the amount of indirect tax due on the transaction. The transaction data 444 may be received from the payment network server 408 and may comprise a second identifier indicating the rate or amount of indirect tax due on the transaction.

The first identifier and the second identifier can be the same or different. The first and/or second identifier comprises one or more of: product category, merchant category, and tax information.

In an implementation, the calculated amount of tax due on the transaction is deducted after the settlement with the issuing entity. Further, the deducted amount may be forwarded 438 to the tax collecting entity before the settlement with the acquiring entity.

Although the foregoing description relates to transactions occurring at physical stores, it is envisioned that embodiments of the invention may be adapted for online transactions via the Internet. In other words, embodiments of the invention do not differentiate how goods or services are offered for sale and delivered.

For conciseness, the following description may only refer to a single entity, e.g. one consumer, one merchant, one tax receipt entity. However, it is to be understood that the methods and systems described herein can be adapted to accommodate multiple entities (i.e. multiple consumers, government agencies and/or merchants). Compared to the current indirect tax collection mechanism, embodiments of the invention advantageously allows governments to minimize delays in receiving tax revenue and also minimize leakages (i.e. transactions occur and taxes are due but the taxes are not paid by intermediaries and/or consumers).

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

1. A method for collecting indirect tax associated with a transaction, the method being performed using a tax collection module, and comprising:
determining that an indirect tax is due on the transaction having a transaction value;
calculating the amount of indirect tax due on the transaction;
deducting the calculated amount of indirect tax due on the transaction from the transaction value at a time associated with settlement of the transaction; and
forwarding the deducted amount to a tax collecting entity at the time associated with settlement of the transaction.

2. The method as claimed in claim 1, wherein determining that an indirect tax is due on the transaction comprises checking transaction data associated with the transaction, the transaction data comprising an identifier indicating that an indirect tax is due on the transaction.

3. The method as claimed in claim 2, wherein calculating the amount of indirect tax due on the transaction comprises checking transaction data associated with the transaction, the transaction data comprising an identifier indicating the rate or amount of indirect tax due on the transaction.

4. The method as claimed in claim 3, wherein the identifier indicating that an indirect tax is due on the transaction and the identifier indicating the rate or amount of indirect tax due on the transaction are the same.

5. The method as claimed in claim 3, wherein the identifier indicating that an indirect tax is due on the transaction or the identifier indicating the rate or amount of indirect tax due on the transaction comprises one or more of: product category, merchant category or tax information.

6. The method as claimed in claim 1, wherein the transaction is an electronic payment transaction and the transaction is settled between an issuing entity and an acquiring entity, through a payment facilitator.

7. The method as claimed in claim 6, wherein the time associated with settlement of the transaction starts when the transaction is first settled between the issuing entity and the payment facilitator, and ends when the transaction is finally settled between the acquiring entity and the payment facilitator.

8. A tax collection module comprising:
at least one processor; and
at least one memory including computer program code;
the at least one memory and the computer program code configured to, with at least one processor, cause the tax collection module at least to:
determine that an indirect tax is due on a transaction having a transaction value;
calculate the amount of indirect tax due on the transaction;
deduct the calculated amount of indirect tax due on the transaction from the transaction value at a time associated with settlement of the transaction; and
forward the deducted amount to a tax receipt module at the time associated with settlement of the transaction.

9. The tax collection module as claimed in claim 8, further caused to check transaction data associated with the transaction to determine that an indirect tax is due on the transaction, the transaction data comprising an identifier indicating that an indirect tax is due on the transaction.

10. The tax collection module as claimed in claim 9, further caused to check transaction data associated with the transaction to calculate the amount of indirect tax due on the transaction, the transaction data comprising an identifier indicating the rate or amount of indirect tax due on the transaction.

11. The tax collection module as claimed in claim 10, wherein the identifier indicating that an indirect tax is due on the transaction and the identifier indicating the rate or amount of indirect tax due on the transaction are the same.

12. The tax collection module as claimed in claim 10, wherein the identifier indicating that an indirect tax is due on the transaction or the identifier indicating the rate or amount of indirect tax due on the transaction comprises one or more of: product category, merchant category or tax information.

13. The tax collection module as claimed in any one of claim 8, wherein the transaction is an electronic payment transaction and the transaction is settled between an issuing entity and an acquiring entity, through a payment facilitator.

14. The tax collection module as claimed in claim 13, wherein the time associated with settlement of the transaction starts when the transaction is first settled between the issuing entity and the payment facilitator, and ends when the transaction is finally settled between the acquiring entity and the payment facilitator.
